(19) United States
(12) Patent Application Publication
(10) Pub. No.: US 2009/0267891 A1
(43) Pub. Date: Oct. 29, 2009

(54) VIRTUAL PAPER

(76) Inventor: Bamidele Ali, Wauwatosa, WI (US)

Correspondence Address: Bamidele Ali, 4133 North 96th Street, Wauwatosa, WI, 53222, US

(21) Appl. No.: 12/430,798

(22) Filed: Apr. 27, 2009

Related U.S. Application Data
(60) Provisional application No. 61/048,112, filed on Apr. 25, 2008.

(51) Int. Cl. G09G 3/34

(52) U.S. Cl. 345/107

(57) ABSTRACT

A virtual paper system configured to receive, store and display data. The virtual paper system comprises a virtual paper device having processing electronics and a memory device coupled to the processing electronics. The virtual paper device further includes a display coupled to processing electronics and configured to be viewed from a front-side of the virtual paper device. The display is also configured to be a touch screen display. The virtual paper device also includes communication electronics configured to provide data communication with at least one of an external device and an external network, a power system configured to provide power to the virtual paper device and an encapsulation layer. The encapsulation layer is configured to cover the front side, sides and at least a first portion of a backside of the virtual paper device. The virtual paper system further comprises a user interface device configured to interact with the display of the virtual paper device. The user interface is an elongated device that includes a first end and a second end, wherein the first end is configured for direct data entry to the display. Further, the virtual paper device is configured to distinguish between the first end and the second end of the user interface device.

### CROSS-REFERENCE TO RELATED PATENT APPLICATIONS

This application claims priority from Provisional Application U.S. Application No. 61/048,112, filed Apr. 25, 2008, incorporated herein by reference in its entirety.

### FIELD OF THE INVENTION

The present invention relates generally to a virtual paper device. More particularly, it relates to the fabrication and use of a flexible ultra thin hybrid organic, passive-active matrix, electroluminescent device, wherein the device is used as an analog-to-digital conversion substrate capable of high capacity data storage, wireless communications (e.g., Bluetooth, RF, Wi-Fi), handwriting recognition, voice recognition, global positioning, imaging, computer emulation, telecommunications, graphics display, and direct digital display.

### BACKGROUND

The paper industry is the world's largest consumer of wood. Each year 535 million trees and more than 12 billion gallons of oil go into manufacturing both printing and writing paper. Thus, over 12,000 square miles of forests are cut every year to satisfy this demand. The paper and pulp industry ranks first in the use of industrial processed water, third in toxic chemical releases, and fourth in emissions of air pollution known to impair respiratory health: Toluene, Methanol, Chlorine Dioxide, Hydrochloric Acid, and Formaldehyde.

The advent of computers, PDA(s), and other generic electronic user interface devices have not eliminated our reliance on or consumption of paper as a data display and data storage (memory) methods. Computer are often too bulky and don't allow for ease of use in situations where users require an immediate data capture apparatus.

Difficulty of use, power consumption, weight, lack of reliability, lack of portability, lack of durability, and overall physical dimensions have limited the effectivity of the previously mentioned electronic devices. Use of writing paper has no associated learning curve, is highly flexible, and is typically 100% accurate (depending on the legibility of the user's writing) to user input. However, data storage presents a number of challenges and risk(s) especially for critical user data (e.g. medical records).

There is still a need in the art for a user friendly, low profile, low power consuming, light weight, flexible, rugged, direct analog input to digital display.

### SUMMARY

One object of the present invention is to provide a both present day computer, graphic paper and the like without loosing any of the functionality present by both media. A hybrid organic electroluminescent device can provide a low power consuming, flexible, ultra thin, light weight functionality that allows consumers to maintain a widely used data recording methodology—alphabetic script. This will ensure that this next generation computer does not disenfranchise or disengage the technically savvy or the technical novice.

A preferred embodiment includes a virtual paper system configured to receive, store and display data. The virtual paper system comprises a virtual paper device having processing electronics and a memory device coupled to the processing electronics. The virtual paper device further includes a display coupled to processing electronics and configured to be viewed from a front-side of the virtual paper device. The display is also configured to be a touch screen display. The virtual paper device also includes communication electronics configured to provide data communication with at least one of an external device and an external network, a power system configured to provide power to the virtual paper device and an encapsulation layer. The encapsulation layer is configured to cover the front side, sides and at least a first portion of a backside of the virtual paper device. The virtual paper system further comprises a user interface device configured to interact with the display of the virtual paper device. The user interface is an elongated device that includes a first end and a second end, wherein the first end is configured for direct data entry to the display. Further, the virtual paper device is configured to distinguish between the first end and the second end of the user interface device.

Another preferred embodiment includes a virtual paper device configured to receive, store and display data. The virtual paper device comprises processing electronics, a memory storage device coupled to the processing electronics and a display coupled to the processing electronics. The display is configured to be viewed from a front-side of the virtual paper device and is configured to be a touch screen display. The virtual paper device further includes communication electronics configured to provide data communication with at least one of an external device and an external network and a power system. The power system is configured to provide power to the virtual paper device and includes an on-board energy storage device. The virtual paper device further includes an encapsulation layer configured to cover the front side, sides and at least a first portion of a backside of the virtual paper device.

Another preferred embodiment includes a user interface device configured to interact with a display of a virtual paper device. The user interface device comprises an elongated body having a first end and a second end. The first end and the second end exhibit different properties and are distinguishable by the display.

### BRIEF DESCRIPTION OF THE DRAWINGS

FIG. 1 is a top down layered view of the virtual paper device showing various layers comprising the device according to an exemplary embodiment.

FIG. 2 is a high level view of the virtual paper device.

FIG. 3 is a side view of the virtual paper device showing the positioning of the various layers according to an exemplary embodiment.

FIG. 4 is user interface device for interactive with the virtual paper device.

FIG. 5 is a side view of the mechanical packaging configuration.

FIG. 6 is a view of the pixel illumination and design optical crosstalk that will enter the user interface device.

FIG. 7 is a graph showing projected optical efficiency data as a functional of user interface device angle perpendicular to the incident virtual paper device surface.

FIG. 8 is a graph showing projected optical efficiency data as a functional of user interface device angle not perpendicular to the incident virtual paper device surface.

FIG. 9 is a view of the device back controller board enclosure and transparent back cover.

FIG. 10 is a block diagram showing the various systems and electronics of the virtual paper device.

### DETAILED DESCRIPTION

The virtual paper device may be comprised of an outer cover which incases a tft-backplane, power generation and power harvesting devices, data storage components, memory components, controller board and the organic electroluminescent layers (display).

The organic electroluminescent device (virtual paper device) is comprised of a stack-up of vapor deposited molecular layers between two electrodes. The layers are chemically doped to promote some specifically desired electrical properties. The doping levels may be adjusted so that when a bias (e.g., and electric potential) is placed across the organic layers, the electrons are forced from an electron emission layer towards holes that are forced from a hole transmission layer. These electrons recombine in a carbon based organic layer and release photonic energy. At least one of the electrodes is fabricated from a transparent material to allow light photons to pass through. The anode and cathode, with organic materials in between, form a matrix that function as pixels or segmented photon light channels.

The fabrication of organic electroluminescent materials consists of the vaporization of a carbon bonded chemicals or gases in conjunction with a metallic catalysts, such as Fe (Iron), Al (Aluminum), Mg (Magnesium, Ag (Gold), Au (Silver) or other suitable metal to create an organic stack-up of material. The use of a metallic catalysts, saturated with carbon atoms C60, C70 or C80, formulate into buckminsterfullerene (fullerenes). Each carbon atom is bonded by three adjacent carbon atoms via covalent bonds to form a sphere or “Bucky Ball.” Each Bucky Ball sphere is approximately 1 nanometer in diameter. The structure type determines electrical and mechanical properties of the individual Bucky Balls, SWNT (single wall nanotube), or MWNT (multi-wall nanotube). Given the metallic nature of the catalyst, oxidation must be prevented so that material performance is not degraded. Therefore, encapsulation, which provides a reliable safe guard for organic electroluminescent devices, is essential to material performance and overall reliability.

The organic light emitting diode layers consisting of C60, C70, or C80 “Bucky Balls” can be deposited on to various substrate materials including Al (Aluminum), Mg (Magnesium, Ag (Gold), Au (Silver), Stainless Steel, and various polymer layers. These substrates give a advantage over the typical glass substrate layers in that they can withstand greater magnitudes of force from consumer usage.

The utilization of both rugged and semi-flexible substrates allows the product size and functional scope to be further miniaturized into a package of credit card like dimensions. The approximate 2″×3.5″ size portable display device is ultra thin with analog-to-digital conversion substrate capable of high capacity data storage, wireless communications (e.g., Bluetooth, RF, Wi-Fi), handwriting recognition, voice recognition, global positioning system, imaging (including biometrics), computer emulation, telecommunications, graphics display, direct digital display, and randomly revolved 6-20 character manipulation used for secure financial processing (randomly generated credit card numbers).

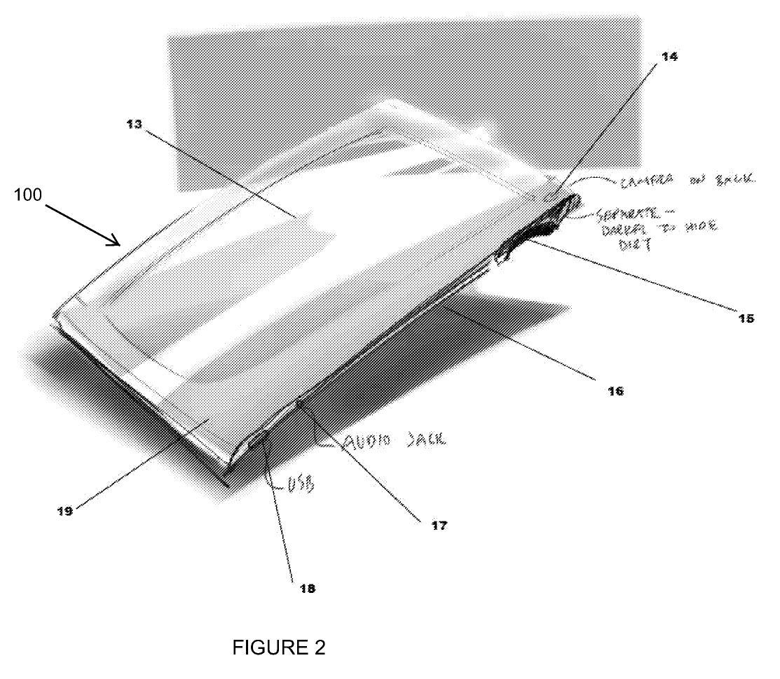

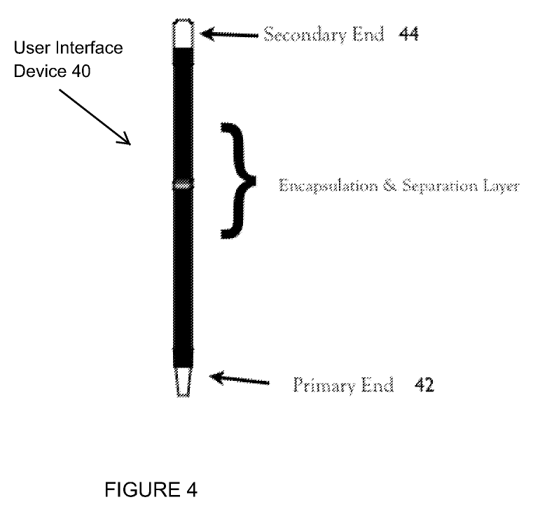

Referring to FIG. 2, the present application relates to the fabrication and utilization of an encapsulated input and display device (virtual paper device 100) comprised of a solid state display material, ultra thin power source, piezoelectric system and photovoltaic layers for power harvesting, a controller board to drive the display and process data, a user interface device 40 (see FIG. 4) mechanism to allow users to write on the display surface, display surface touch response, a software operating system, user applications (such as financial encoding software) and encapsulated mechanical covers 13 used for both physical integrity and light manipulation.

According to a preferred embodiment, the “Virtual/Digital Paper” device 100 is ultra thin (e.g., 1.58 mm to 38.1 mm thick), low power consuming (e.g., less than 20 watts), semi-flexible (e.g., bend radius up to 175 degrees), electroluminescent (>30 Cd/m²), with scribe (user interface device 40), touch (e.g., thermal, ultrasonic, capacitive, resistive touch sensing mechanisms), and keyboard (onscreen illuminated keys and external keyboard) input capabilities.

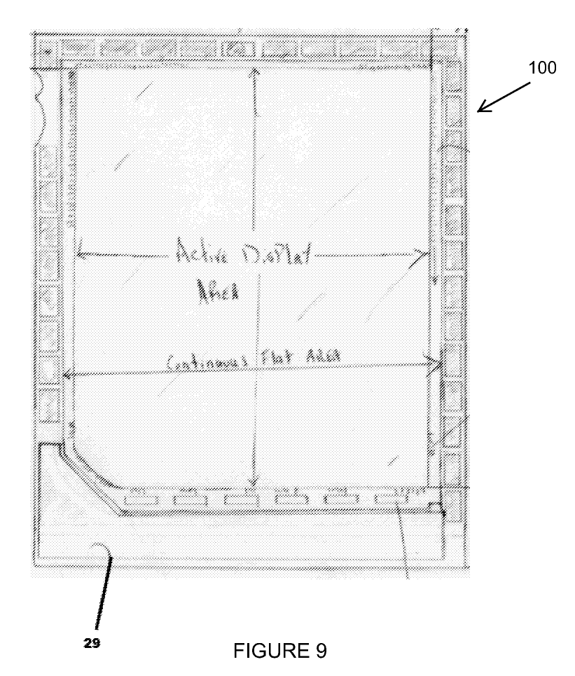

Referring to FIGS. 2 and 9, the device front cover 19, back cover 16, and controller board access panel 29 may be comprised of glass, metal (e.g., aluminum, magnesium, steel), polymer or plastic. The balance of the following functional metrics is key to insuring mechanical integrity through the manufacturing process, mechanical stability, mechanical reliability, and optical performance: impact strength, functional thickness, transparency, scratch resistance, moisture permeability, flammability, thermal integrity, expansion and contraction properties, electrical isolation. The cover and substrate materials will withstand up to 200° C. Each substrate and cover will have a plate stiffness

$$D = \frac{{Et}^{3}}{12 ( 1 - {v}^{2} )}$$

between D=316 to 6500 at 1 mm to 2.85 mm in thickness. The materials have a low moisture permeability of <0.01 g/m2·24 hr. The cover and substrate materials exhibit >60% transparency to wavelength within the visible spectrum.

Referring to FIG. 2, the cover 13 and substrate materials may be composed of, but not limited to, one or more of aluminum, magnesium, steel, acrylic, polystyrene, polycarbonate, polyetherimide, teflon, olefin, or a polyimide. The materials can be used independently or in conjunction with one another to enhance the structural performance.

The cover and substrate mounting is composed of either an independent full-area cover and functional layer or an integrated full-area and functional layers. The cover and substrate unions are screw joint, adhesive, weld joint, and snap fit.

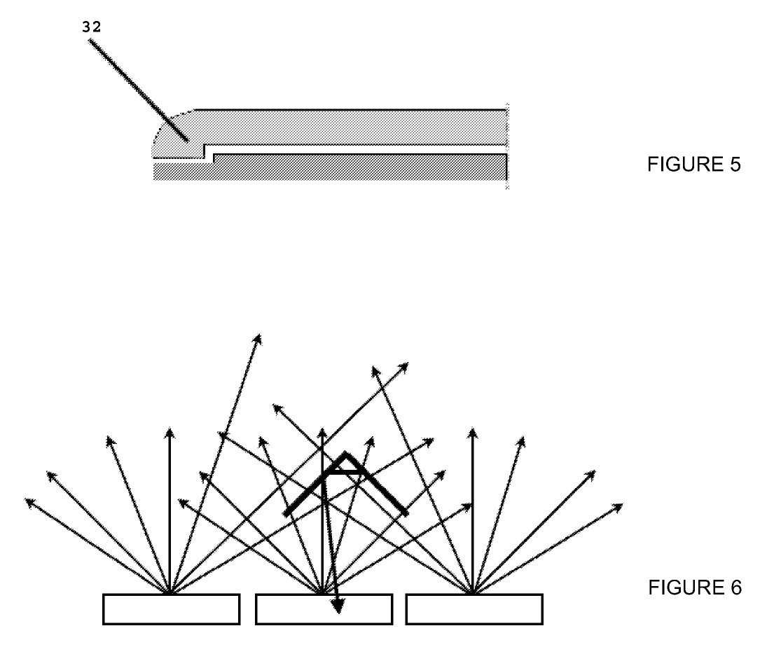

Referring to FIG. 5, the industrial design of the input and display is such that the device is rectangular in shape with chamfered corners 32 and bottom front cover. The device has between 8.5 inches and 17.5 inches of active display area. Preferably, the entire device stack-up is <1.5 inches in thickness. However, the device may vary considerably in length, width and thickness. For example, the device thickness may vary from less than 14 inch to 2 inches thick and the device length and width may be the size of a credit card (or smaller) or the size of a billboard (or larger). Furthermore, the display need not be rectangular, but may take on any shape (e.g., ellipse, polygon, rounded corners, arc edges).

Referring to FIG. 2, the virtual paper device 100 provides accessible ports for USB, mini-USB, HDMI, mini-HDMI and audio video ports. The device has a fully integrated video and still camera in either the top or bottom section or the front and back partitions of the device. The device has a plurality of cut-outs 15 in it's side partitions for users to adjust the device speaker volume, put the device in standby, or power cycle the device. A plurality of external LEDs 14 are present to serve as device status indicators. The device is either external curved or flat as viewed orthogonal from it's front to back covers.

The virtual paper device 100 utilizes organic light emitting diodes (OLEDs) to create an ultra-thin light emitting surface upon which users may write using their fingers, a polymer writing device, a carbon single wall nanotube (SWNT), a carbon multi-wall nanotube (MWNT), or a magnetic writing device e.g., rare earth magnet).

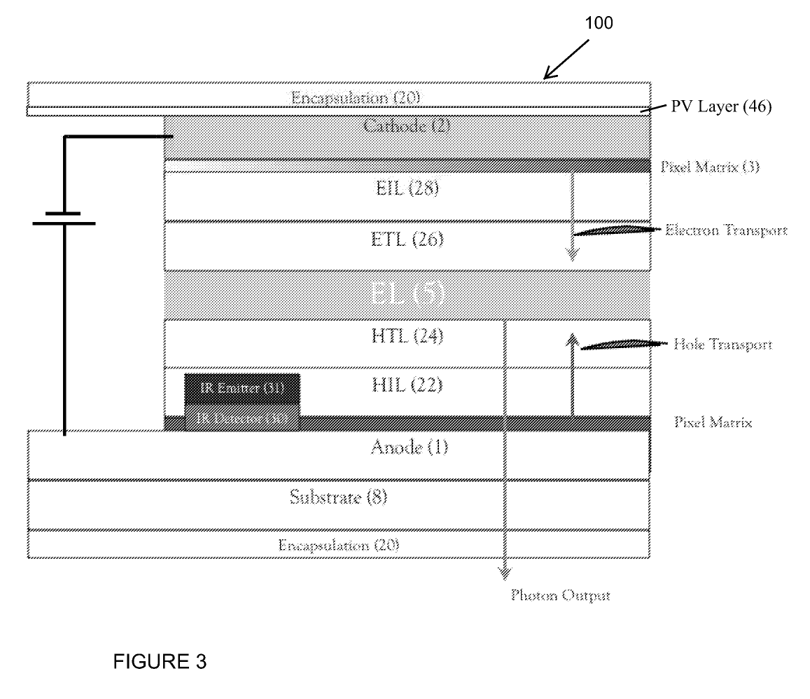

The light emitting surface may be comprised of organic material deposited on either a cathode 2 or an anode 1 layer (see FIG. 3). The cathode and anode may be deposited onto a substrate or in combination with substrate materials composed of glass, plastic, silk, metal/metal alloy, or carbon fiber Substrate (8) (see FIG. 3). When a bias (e.g., electric potential) is applied across this surface the organic material, it emits photons (light). The emitted light may be of multiple wavelengths (red, orange, yellow, blue, green indigo, violet, infrared, and ultraviolet). The wavelengths may be configured at the factory prior to delivery, or by the end user.

The organic material may be deposited in a variety of ways, which may include high pressure carbon monoxide deposition (HIPCO), chemical vapor deposition (CVD), and plasma deposition, such as, plasma enhanced CVD (PECVD).

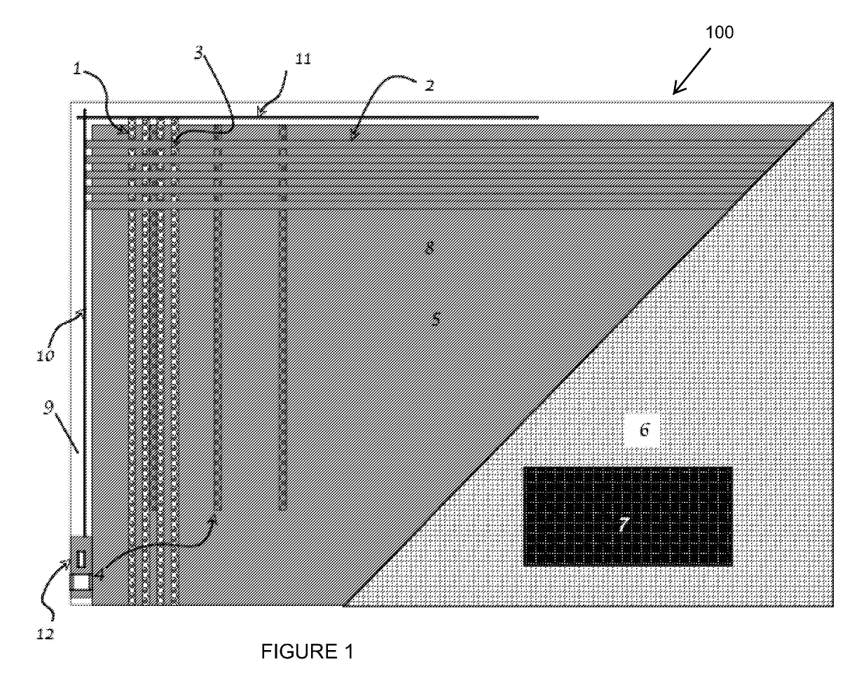

Referring to FIGS. 1 and 3, the intersection of the cathode 2, anode 1 and the organic material make up the light emitting pixel structure upon which an encapsulation layer 20 is placed to secure the device from moisture and external physical damage. The encapsulation layer 20 may also acts as a heat sink to delocalize the thermal capacity of the device 100. The connection between each pixel configuration and the read out electronics may also be completed with the use of nanotube wiring to maximize reliability and performance.

Preferably, the organic pixel structure requires less than 10 volts per pixel to generate light within the visible light spectrum. Power from the device 100 may be generated by the use of a single or multiple battery cells, virus synthesis battery power, solar power, power over USB connectivity and a wall outlet adapter. The external power sources may be used to recharge or supplement the device's internal power supplies.

A microelectromechanical system (MEMS) may be used to communicate to and accept user inputs to device memory. The device may be configured so that the carbon atoms store the charge of the user action items in conjunction with on board access memory. The touch screen may be configured to be responsive to the user's fingers, polymer writing devices, magnetic writing devices, carbon fiber writing devices and glass writing devices.

Rare earth magnetic devices may also be used to manipulate the electrical characteristics of the carbon fullerene structures (device substrate) both with and without the use of a microelectromechanical touch screen. The carbon structures (fullerenes C60, C70 or C80) are doped with a chemical such that the OLED material responds to changes in electrical properties of the device as a specific strength of magnetic field comes within an adjustable activation range (e.g., 0-1.5 inches) from the device surface. The change in electrical properties of the carbon structures are transmitted to the processor and back to the pixel coordinates to either turn the fullerenes, or photon emissions, on or off. This switch shows tip to the user as either a fully illuminated pixel or a non-illuminated pixel.

The rare earth magnetic device may comprise a single rare earth magnet of variable magnetic strength. The rare earth magnetic user interface device (writing device) may be encapsulated in a material that does not allow magnetic fields to escape from any surface other than the tips(s) or user interface surfaces of the device. The strength of the magnetic field may be controlled by a switch that either varies the electrical current in the user interface device (UID) or by varying the thickness of the insulating material, thus varying the magnetic field resonating from the UID. One end of the magnet has a magnetic strength that varies from the opposite end. This configuration allows one side of the magnetic device to serve as a writing mechanism and the other end to serve to erase user interface strokes by varying the different electrical characteristics of the carbon structure.

Referring to FIGS. 1 and 3, several layers within an encapsulated “Virtual/Digital Paper” device 100 are shown. Below user interface encapsulation layer 20 is a passive or active pixel matrix grid 6, an active pixel matrix 7, a matrix pixel 3, nano-memory channel(s) 4, row and column data transfer line(s) 10 and 11, respectively, electroluminescent organic material 5, deposition substrate 8, anode array 1, transparent cathode array 2, and electron/hole transport regions comprising a hole injection layer (HIL) 22, a hole transport layer (HTL) 24, an electron transport layer (ETL) 26 and an electron injection layer (EIL) 28.

Encapsulation layer 20 and substrate 8 are comprised of material that is resistant or electrically unresponsive to environmental conditions, such as humidity, mechanical failures due to thermal transfers, high impact, or ambient light input, including changes in ambient light input. Substrate layer 8 may be fabricated from a polymer, carbon graphite, glass substrate, or quartz. Preferably, substrate layer 8 should be no more than 1 mm thick.

According to a preferred embodiment, anode array 1 is deposited on the substrate. The deposition process may utilize a mask to form anode array 1. The anode array may be any conductive material which is either opaque or transmissive to light from the visible light spectrum to the infrared light range, such as silicon (SiO) doped with Al (Aluminum), Au (Silver), Ag (Gold), Pt (Platinum), Mg (Magnesium), ITO (Indium Tin Oxide), ZnO (Zinc Oxide), or any alloy containing these metals. Preferably, the anode is sputter or enhanced plasma vapor deposited on the substrate at thickness between 50 nanometers and 0.2 um.

HIL 22 and HTL 24 are deposited onto anode array 1. Preferably, HIL 22 and HTL 24 are sputter or enhanced plasma vapor deposited. HIL 22 and HTL 24 maybe deposited as individual layers, or jointly as a single layer. HIL 22 may be comprised of copper phthalocyanine (CuPc), or a combination of Nano Bucky Balls (NBB: C60, C70, C80) and copper phythalocyanine (CuPc), to form a NBB(C60)/CuPc molecular bond with anode array 1. This prevents anode HIL/HTL junction material degradation and improves efficiency. HTL 24 may be comprised of N,N′-bis(1-naphthyl)-N,N′-diphenyl-1,1′-biphenyl-4,4′-diamine (NPB) or of a tetraminobiphenyl derivative such as 3,3′,5,5′-tetrakis(p-tolyldiamino)biphenyl (TTAB). Each layer may be chemically doped to either enhance or suppress certain electrical responsivities and properties, such as, electron transport or electron spin etc. HIL 22 or combined hole injection-hole transport layer are preferably deposited at a thickness of approximately 60 nanometers.

Additional layers of material maybe added in between the anode array 1 and the subsequent HIL 22 and HTL 24, such as a Hole Blocker Layer (HBL) or an Electron Blocker Layer (EBL) for blocking holes or electrons.

The host emitter or emission layer (EL) 5, which is the Organic Electroluminescent Material, is preferably deposited onto HTL 24 or the combined hole injection hole transport layer (HIHTL). Preferably, the EL 5 is sputter or enhanced plasma vapor deposited. EL 5 emits light when electrons and holes recombine in this region. The organic material comprising EL 5 preferably has a luminance >5 cd/A. EL 5 may include material such as tris(8-hydroxyquinolinato)aluminium (Alq) doped with a fluorescent dye. The doping material preferably has a high photoluminescent quantum yield and high EL efficiency. Various dopant materials, or the combination of materials, may be used to generate light with in visible light spectrum (400 nm-700 nm). An example of a dopants used for green EL devices is coumarin 6 (C-6) and coumarin-545T (C-545T); 3-(2′benzothiazolyl)-7-diethylaminocourmarin & 10-(2-benzothiazolyl)-1,1,7,7-tetramethyl-2,3,6,7-tetrahydro-1H 5,11H-[1]benzopyrano[6,7,8-ij]quinolizin-11-one respectively. The organic material is preferably doped at a concentration level of coumarin, or the like, greater than or equal to 1% to maintain luminant efficiency. Subsequently, a couramin derivative (couramin 525, couramin 535, couramin 540A, couramin 545) or quinacridone derivative may also be used as green light EL 5 dopants. Alq, doped with other fluorescent dyes or combinations of dyes, is used to emit other colors such as blue, blue-green, red etc. Using sputter or enhanced plasma chemical vapor deposition, EL 5 is preferably deposited between 5 nanometers and 200 nanometers thick.

Electron Transport Layer 26 (ETL) Electron Injection Layer 28 (EIL) comprised Lithium Fluoride (LiF) or a combination of Lithium Fluoride, NanoBuckyBall (NBB) C60 or solely NanoBuckyBall (NBB) C60. The use of NBB, solely or in combination with another material, lowers the power losses associated with electron transport through ETL 26. The NBB also reduces the junction resistance associated with the electron transport layer cathode bond. ETL 26 and EIL 28 can be deposited on EL 5 (Alq) in separate layers or combined as a single electron transport electron injection layer (ETEIL). The combination of such layers is preferably deposited at a thickness between 5 nanometers and 100 nanometers using sputter or chemical plasma chemical vapor deposition.

The use of NBB (C60, C70, C80), in conjunction with HIL, 22, HTL 24, ETL 26, and EIL 28, improves the chemical bond with anode array 1 and cathode array 2. The use of NBB (C60, C70, C80), in conjunction with HIL 22, HTL 24, ETL 26, and EIL 28, also reduces the junction resistance, for improved efficiency, and suppresses the crystallization of the organic materials. With respect to FIG. 3, it is important to note that the “pixel matrix” layers are pseudo-layers and have been inserted to illustrate photon transfer in an organized fashion. Thus, EIL 28 and HIL 22 are directly in contact with cathode array 2 and anode array 1, respectively.

Cathode array 2 is preferably deposited to a thickness between 50 nanometers and 200 nanometers using sputter or enhanced plasma vapor deposition. The deposition process may utilize a mask to form cathode array 2. The cathode is preferably comprised of transparent material that will allow both visible light and infrared light to pass through with minimum refraction and energy loss, such as Aluminum (Al), Magnesium (Mg), Gold (Ag), Silver (Au), Platinum (Pt) or an alloy of these metals doped silicon oxide (SiO).

Encapsulation layer 20 is preferably deposited onto cathode array 2 at a thickness of less than 1 mm. Delamination of the encapsulation layer(s) severely degrades the organic material and thus reduces the device performance. Encapsulation should completely encompass the top surface and side surfaces to bond with at least 30% of the bottom device surface. The encapsulation material is preferably composed of a polymer based material that is either sputter or plasma enhanced chemical vapor deposited to provide a smooth user interface surface. The material should preferably readily allow magnetic fields to pass through in order to manipulate the organic substrates electrical properties.

Referring to FIG. 6, the mechanical configuration of the organic layers is deposited as either rectangular or square display pixels on the “Virtual/Digital Paper” Device substrate. The spatial resolution of the pixels is between 25 micron and 350 microns, although larger and smaller pixel spacing may be provided. Each sub-pixel is configured in, but not limited to, a striped, delta, or continuous block configuration. In the case of the continuous block configuration, a controlled filter layer will be used to provide the display granularity needed to articulate an image or video.

The final layers of the pixel configuration comprise the transparent backplane. The transparent backplane consists of a series of thin film transistors, a drive component and memory latch component. Within the pixel areas is a photodiode for each pixel in the array, used to detect incoming light.

The “Virtual/Digital Paper” device 100 processes incoming data that is delivered directly from the users interface device, user touch or data streams via wireless on tethered connectivity. Preferably, the device's operating systems is built on either the Linux, Java, or .Net architecture. Preferably, the architecture is open source to allow users to develop relevant applications for utilization.

The controller board is constructed on a flexible polymer substrate made of polystyrene, polycarbonate, polyetherimide, teflon, olefin, or a polyimide. Device components are assembly on opposing sides to minimize area consumption and reduce thermal conductivity.

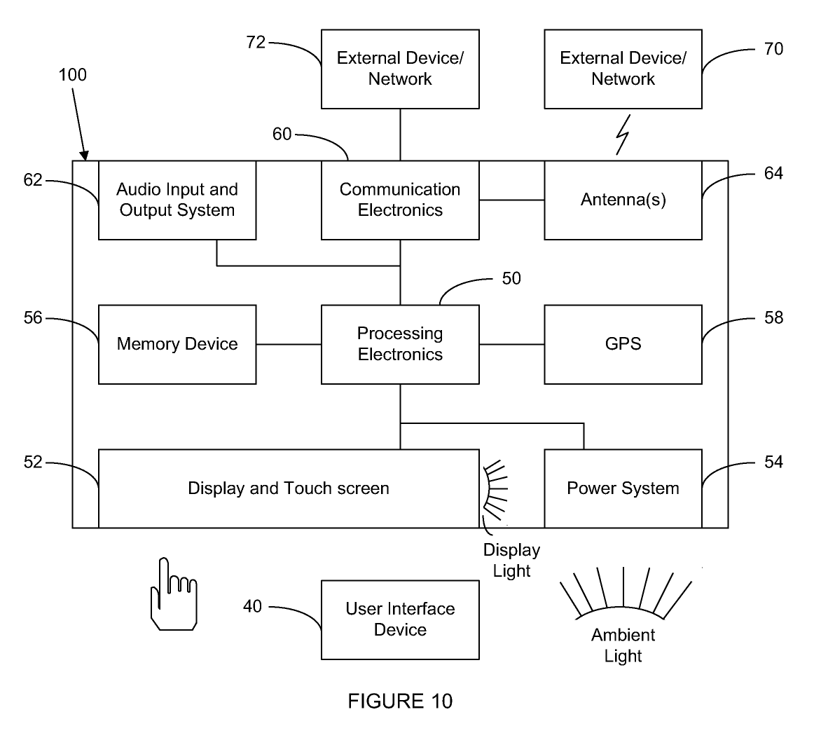

Referring to FIG. 10, in a preferred embodiment, the virtual paper device 100 includes processing electronics 50, a display and touch screen 52, a power system 54, a memory device 56, a GPS 58, communication electronics 60, an audio input and output system 62 and one or more antennas 64.

The processing electronics 50 preferably comprise 1-2 microprocessors, comparator circuitry, buffer circuitry, diodes for electrostatic discharge stability, an array of passive input output components and feedback OLEDs. The memory device 56 preferably includes memory storage chips (which may include, or be replaced by, nano-tubular layers that function as memory capacity units). These components, and others, may be mounted on the flexible controller board using conventional techniques. Preferably the virtual paper device 100 also includes wireless communication electronics/circuitry, GPS circuitry, power regulation circuitry, audio input/output circuitry.

The microprocessors are preferably less than 100 nanometer devices with gate lengths less than 50 nanometers. The microprocessors preferably have both SRAM and DRAM capability. The microprocessors footprint is preferably less than 1.5″×1.5″. In an exemplary embodiment, buried and blind vias, capacitance and resistance may be used in the circuit board manufacturing process to couple the microprocessors with supporting electronic components.

Memory storage components preferably support synchronous and dynamic access. The footprint for the memory storage components is preferably less than 0.5″×0.5″. All memory internal to the device is preferably non-volatile memory. Such memory components used in this device can be, but are not limited to, carbon nano-tube enhanced nano-memory-carbon nano-tubes connected to an array of transistors capable of storing 3 to 12 bits of data.

The device preferably includes communication electronics 60 configured for wireless data communication with an external device or network 70. Wireless data transmission formats may include one or more of Bluetooth, Wi-Fi, ZigBee, Z-Wave, IrDA, WiMAX or any other type of past, present or future wireless technology. The wireless capability may be built into the device, which include one or more antennas 64 for wireless communication. Alternatively, the wireless capability may be provided by an external device that plugs into, or is otherwise communicably coupled to, the communication electronics 60 via a communication interface. This may include a wireless card designed to be inserted in a slot in the device, a wireless USB adapter configured to be inserted into a USB port on the device 100, or any other type of wireless communications device coupled to the device via a wired or wireless connection. The device 100 includes communication electronics 60 configured for wired data communication with an external device or network 72 utilizing one or more of USB, HDMI, LAN, Firewire, or any other past, present or future wired technology. The device 100 may include an interface for providing one or more of the wired data transmission capabilities. The device preferably transmits data at no less than a 100 Mb/s transfer rate or no less than 25 frames per second (fps). The wired and wireless interfaces my also be used for accessory connectivity to the device.

In one embodiment, the communication electronics 60 may be equipped with mobile data and telecommunications capability for sending and receiving incoming calls and data over a mobile telecommunications network. For example, the device may be equipped with electronics for communicating over a 3G or 4G network to send/receive phone calls, text messages and pages. To facilitate sending/receiving phone calls, the device may include input and output audio system 62 configured with input and output electronics, such as a microphone and one or more speakers. Alternatively, the device may include a wired or wireless interface for connecting external audio input and output devices, such as a microphone, headphones, speakers or an ear piece that includes a microphone and speaker. In a wireless configuration, the device may be configured to communicate with the external audio devices over a personal area network (PAN) using Bluetooth, ZigBee, Z-Wave, IrDA, or ultra-wideband (UWB). In a wired configuration, the device may be configured to communicate with the external devices using mini-jack ports, Firewire ports or USB ports. The user may utilize these external devices to facilitate sending/receiving phone calls. The audio input capability may also be used to record audio information or receive voice commands or prompts from a user to perform certain functions. For example, the user may prompt the device to initiate a program, perform a function within a program, initiate a phone call, look up the contact information of an individual or company, perform an internet search, etc.

The virtual paper device 100 may also be equipped with GPS 58 capabilities to determine the location of the device. The GPS 58 may also be used in conjunction with a software application installed on the device to provide directions to a particular location and to monitor travel to the identified location.

The virtual paper device 100 may also be equipped with a display and touch screen 52. As described above, the touch screen may included different types of sensing mechanisms, such as thermal, ultrasonic, capacitive and resistive. In a preferred embodiment, the touch screen sensing mechanism is ultrasonic. Using this touch sensing mechanism, ultrasonic waves roll across the screen and when interrupted the display and touch screen electronics can determine the location and time of the interruption based on the change in wave properties. The ultrasonic waves may also be used in conjunction with the device cut-outs 15 (see FIG. 2) to determine an appropriate response to a user passing a finger through the cut-out 15 (e.g., power off, switch modes). The device may be configure so that ultrasonic waves roll to the edge of the device, including the cut-out locations. When the users finger passes through the cut-outs it interrupts the ultrasonic waves and the device is able to determine the location of the interruption as being the particular cut-out. In response to the interruption, the device takes the appropriate action (e.g, shuts down).

As described above, the display may be capable of very high resolution (e.g., pixel spacing of between 25 microns and 300 microns). This level of resolution allows the device to display very high quality images with little to no processing. For example, monitors used to display medical images require image processing because the resolution of the images is too high for the display. The resolution of the device display in the present application may be configured to be high enough to display the medical image directly with no image processing.

Referring to FIGS. 1, 3 and 10, the virtual paper device 100 is preferably capable of imaging and scanning with direct display for object capture and device security using display and touch screen 52, processing electronics 50 and memory device 56. An active matrix region 7, defined approximately by a 4″×4″ area, is capable of scan via visible light or Infrared Imaging. This region is comprised of the aforementioned architecture in conjunction with an infrared light emitter 30 and photo detector 31. In active matrix region 7, the device preferably converts infrared light input, received at 1.5 um, to visible light with a wavelength of 520 nm. Photo detector 31 and infrared light emitter 30 are preferably made with an inorganic integration of an InGaAs/InP photo detector and an organic light emitting diode. Incoming light radiation is absorbed by the p-i-n detector which drives the OLED material to emit light or an image at visible wavelengths. The driving voltage of region 7 may exceed the typical device operating voltages of 1.3 volts to 10 volts, extending the device range to an upper limit of 18 volts. Device region 7 may also be used to scan small objects, such as, business cards for direct display and digital storage. Region 7 may also be used to image user digits (e.g., fingers) for secured access to data either stored on or transmitted to the device.

Specific device pixel performance information may be stored both locally and remotely to ensure adequate calibration for display and detection purposes.

Also, there will be a gain map used for signal output referencing located in the device firmware. The gain map, or LUT (look up table) will enable the device to maintain a uniform input modulation independent of the UID (user interface device) 40 degradation in magnetic output.

Referring to FIGS. 3 and 10, the virtual paper device 100 includes power system 54 which provides a single, or multiple, onboard energy storage devices including lithium ion batteries, viral synthesis batteries, thin film batteries or any other past, present or future energy storage technology. Preferably, the batteries are rechargeable and may be recharged using any wired connection, such as a USB connection or an AC wall outlet adapter. The power system 54 may also include one or more solar powered interfaces such as one or more photovoltaic (PV) layers 46 (see FIG. 3) to capture ambient light and light produced by the OLEDs. The solar power interface can be bonded within the device stack-up during the fabrication process. In operation, OLEDs emit light in all directions. A portion of the light is directed toward the user of the device and is used to light up the display. The remainder of the light is emitted away from the user into, and to the sides of, the device. A PV layer 46 may be disposed below the OLED layers (and preferably inside the encapsulation layer 20) to capture the light emitted away from the user into the device. If the OLED layers are all transmissive, ambient light that passes through the OLED layers may be captured by the PV layer 46 disposed below the OLED layers. Furthermore, the PV layer 46 may be a bifacial PV layer 46 such that when the device is flipped over to expose the non-display side of the device, the exposed side of the bifacial layer away from the OLED layers would be capable of capturing the ambient light. The light captured by the PV layers may be used to power the device or to recharge the onboard energy storage devices. Additional PV layers may be disposed around the device structure to capture ambient light. The device may also be equipped with a piezoelectric system to harvest electrical energy from the motion of the device when it is being transported or otherwise subject to environmental vibrations. As the device moves/vibrates the piezoelectric material converts the motion into electrical energy which may be used to power the device or charge the onboard storage devices. The “Virtual/Digital Paper” device 100 may have an integrated piezo sensor and a piezo controller circuitry to provide >1 mW upon device vibration >0.02 inches in displacement. Power management circuitry may be integrated into the main controller board to ensure proper display output and efficient power use and harvesting. The primary source batteries generate between 1 watt and 20 watts of usable power. The device's power generation units should provide the device with a constant voltage between 1 volt and 20 volts DC.

In another exemplary embodiment, a method is provided for creating an electromechanical and/or optical, non-tethered, user interface device (UID) 40 as shown in FIG. 4. UID 40 may be comprised of 2 magnetic units or 2 independent light sources bonded in an end to end configuration corresponding to primary end 42 and secondary end 44. Primary end 42 and secondary end 44 of UID 40 are not limited to, but may comprise, Iron (Fe), Nickel (Ni), Cobalt (Co), Awaruite (Ni³Fe), Wairauite (CoFe) magnetic or light emitting material encapsulated with wood, copper, or aluminum. In a preferred embodiment, UID 40 utilizes optical reflection with a light reflecting material comprised of a microcrystalline structure.

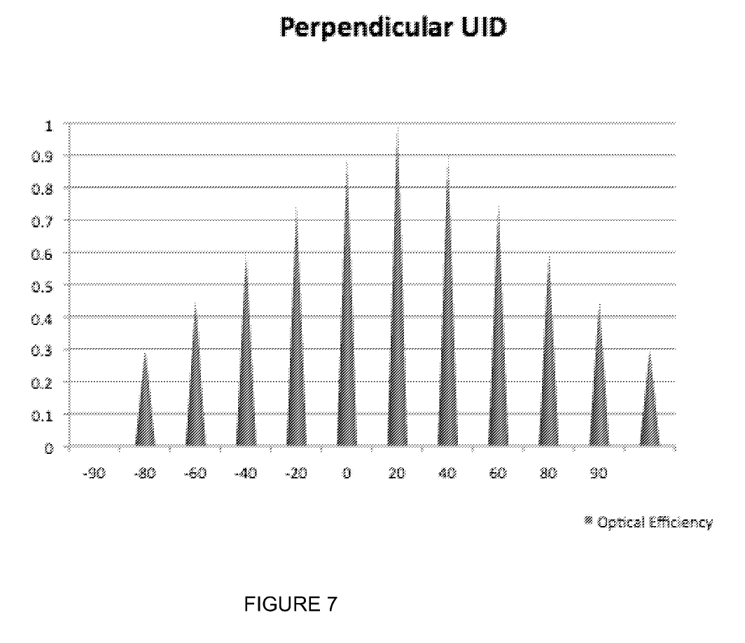

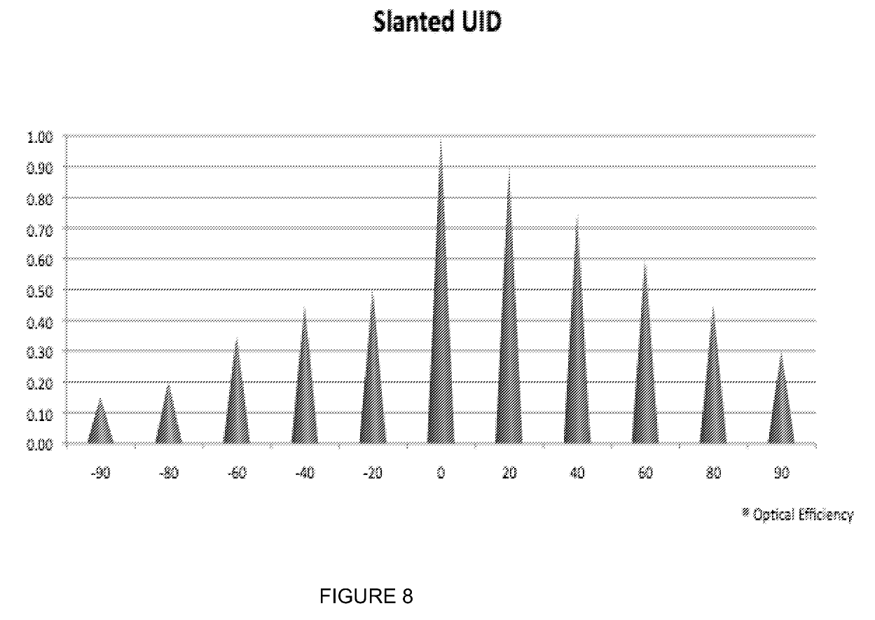

Referring to FIGS. 7 and 8, the most successful utilization of the user interface device (Pen, Pencil used for scribing) is by means of optical reflection. In one embodiment, a reflective tip comprised of a microcrystalline structure may be provided that is configured to allow a conventional pen or pencil to be inserted into the tip (a secondary tip may be provided for the other end of the writing device). In this way, a traditional writing device may be used. Alternatively, a UID 40 may be provided, which comprises a built in microcrystalline tip (preferably a primary and secondary tip). These tips may be configured to be removable. In FIG. 7, the dependent axis is the light reflection efficiency of the user interface device and the independent axis represents the angle at which the user interface device is held. The magnitude demonstrates the magnitude and offset of the optical reflection with respect to a perpendicular alignment with the virtual/digital paper device surface. In FIG. 8, the dependent axis is the light reflection efficiency of the user interface device and the independent axis represents the angle at which the user interface device is held. The magnitude demonstrates the magnitude and offset of the optical reflection with respect to a non-perpendicular alignment with the virtual/digital paper device surface.

Referring back to FIG. 4, the primary end 42, or writing end, of UID 40 preferably has a thickness, at the recommended point of contact with the front cover surface, that is between 0.1 mm and 1 mm in thickness. This thickness ensures that the user interface device cover an entire pixel and sub-pixel set in a RGB delta, or striped configuration. The UID 40 will create a reflective optical pattern across a minimum of a 1×1 pixel array structure. When the user interface device is over a set of sub-pixels it will reflect light from each of the illuminated segments back into the illuminator stack up or into the photo diode of the associated pixel. The wavelengths of the reflected optical signal are magnified via light particle vector recombination and detector to determine which pixel will be turned off once pushed into the saturation region of operation. The Virtual/Digital Paper device pixel is around 35 um×30 um. The UID 40 will reflect light that matches the illuminator light wavelength thus allowing the organic display to serve as a detector at the times when a photodiode is in the ‘off’ configuration. The light reflection pushes photon/electrons into the depletion region of the current layer causing an over-current status to occur which will either be processed by the processor or directly turn the pixel off to create scribed images and pencil/pen strokes or to change the color of the pixel's illumination to simulate user writing. The device utilizes crystalline structures to reflect the light in a precise predetermined position from that being illuminated. The need for a pressure sensor is eliminated because as the user slants the user interface device the number of pixels detecting a reflected light source of the proper wavelength increases and so does the thickness of the line being scribe (e.g., the pixel count that moves from “on” to “off” increases). As the user compresses the surface of the Virtual/Digital Paper device 100 with the UID 40, the magnitude of the light increases and the processor creates a greater contrast (darker line) with the surrounding pixels.

According to another embodiment, UID 40 may be configured to emit light in order to change the electrical properties of the device's light emitting substrate and driving layers (e.g., HIL 22, HTL 24, ETL 26, and EIL 28). The changes in electrical properties of the material may be detected by scanning of row data transfer line 10 and column data transfer line 11 on an active row or column ordered matrix (e.g., all row or all column electronics will be active at all times during the device “on” status). The row or column electronics will measure changes in pixel resistivity and turn on the corresponding row or column readout electronics 12 to display a varying (other than flat field substrate light emission—black pixels/ink, red pixels/ink, green pixels/ink) color for high contrast light conversion of input analog magnetic or light stimulus to output digital light signals.

Secondary end 44 or erasing end of UID 40 may be made from, but is not limited to, Iron (Fe), Nickel (Ni), Cobalt (Co), Awaruite (Ni³ Fe), Wairauite (CoFe) magnetic, light emitting material or optical reflective material using a microcrystalline structure encapsulated with wood, copper, or aluminum. Secondary end 44 material has an optical reflective material that in contrast to the primary end reflects a different wavelength of light by manner of proximity to the detection layer for each pixel. The secondary end will trigger the processor to recall the previous state of the display pixel which serves as a data recall circuit. Secondary end 44, or erasing end, preferably has a thickness, at the recommended point of contact with the substrate surface, that is 0.1 mm to 4 mm thick and will cover a 1×1 pixel matrix up a 5×5 pixel matrix. Secondary end 44 of UID 40 registers with the row and column electronics as an indicator to transmit substrate flat field light (e.g., visually resembles the pixel in an off state or no light output). Secondary end 44 of UID 40 may take a primary functional processing status over the stimulus created in the organic material by primary end 42 of UID 40. The resultant effect is that secondary end 44 of the user interface provides an erasing mechanism for any previous user created inputs. The entire UID 40 dimensions are preferably cylindrical in shape and less than 0.5 inches in diameter and no more than 7 inches in length.

The preferred embodiment of the present application utilizes an OLED display, however, other display technologies may be utilized including LCD, plasma, electro-phosphorescent, or any other past, present or future display technology.

The exemplary embodiments illustrated in the Figures are offered by way of example only. Accordingly, the present disclosure is not limited to a particular embodiment, but extends to various modifications that nevertheless fall within the scope of the appended claims. The order or sequence of any processes or method steps may be varied or re-sequenced according to alternative embodiments.

Describing the disclosure with Figures should not be construed as imposing on the disclosure any limitations that may be present in the Figures. The present disclosure contemplates methods, systems and program products on any machine-readable media for accomplishing its operations. Various components for the embodiments of the present disclosure may be implemented using an existing computer processor(s), or by a special purpose computer processor.

As noted above, embodiments within the scope of the present disclosure include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated.

What is claimed is:

1. A virtual paper system configured to receive, store and display data, comprising:
(a) a virtual paper device, comprising:
(1) processing electronics;
(2) a memory device coupled to the processing electronics;
(3) a display coupled to processing electronics and configured to be viewed from a front-side of the virtual paper device, wherein the display is configured to be a touch screen display;
(4) communication electronics configured to provide data communication with at least one of an external device and an external network; and
(5) a power system configured to provide power to the virtual paper device;
(6) an encapsulation layer configured to cover the front side, sides and at least a first portion of a backside of the virtual paper device;
(b) a user interface device configured to interact with the display of the virtual paper device, wherein the user interface is an elongated device that includes a first end and a second end, wherein the first end is configured for direct data entry to the display, wherein the virtual paper device is configured to distinguish between the first end and the second end of the user interface device.

2. The system of claim 1, wherein the display is and organic light emitting diode (OLED) display.

3. The system of claim 1, wherein the first end of the user interface device is comprised of a reflective material having a microcrystalline structure.

4. The system of claim 1, wherein the virtual paper device is 17.5 inches or less in height, 8.5 inches or less in width and less than 1.5 inches thick.

5. The system of claim 1, wherein the encapsulation layer is comprised of an encapsulation material that includes at least one of glass, metal, polymer and plastic.

6. The system of claim 1, wherein the touch screen display utilizes ultrasonic waves as a sensing mechanism.

7. A virtual paper device configured to receive, store and display data, comprising:
processing electronics;
a memory storage device coupled to the processing electronics;
a display coupled to the processing electronics and configured to be viewed from a front-side of the virtual paper device, wherein the display is configured to be a touch screen display;
communication electronics configured to provide data communication with at least one of an external device and an external network; and
a power system configured to provide power to the virtual paper device, wherein the power system includes an on-board energy storage device; and
an encapsulation layer configured to cover the front side, sides and at least a first portion of a backside of the virtual paper device.

8. The virtual paper device of claim 7, wherein the power system includes at least one of a photovoltaic layer and a piezoelectric system, wherein the photovoltaic layer and the piezoelectric system are configured to provide power to the virtual paper device.

9. The virtual paper device of claim 7, wherein the photovoltaic layer is a bifacial photovoltaic layer.

10. The virtual paper device of claim 7, wherein the on-board storage device includes at least one of a lithium-ion battery, a thin-film battery, and a viral synthesis battery.

11. The virtual paper device of claim 7, wherein the touch screen display utilizes ultrasonic waves as a sensing mechanism.

12. The virtual paper device of claim 7, wherein the display is an organic light emitting diode (OLED) display.

13. The virtual paper device of claim 7, wherein the OLED display further comprises:
a first electrode;
a plurality of organic layers above the first electrode;
a second electrode provided above the plurality of organic layers; and
a substrate layer comprised of a substrate material that includes at least one of a polymer, carbon graphite, glass, or quartz, wherein the substrate layer may be provided below the first electrode or above the second electrode.

14. The virtual paper device of claim 7, wherein the communication electronics are configured for wireless communication using at least one of Bluetooth, Wi-Fi, ZigBee, Z-Wave, IrDA, and WiMax.

15. The virtual paper device of claim 7, wherein the communication electronics are configured for wired communication using at least one of USB, HDMI, LAN and Firewire.

16. The virtual paper device of claim 7, wherein the communication electronics are configured for mobile telecommunications.

17. A user interface device, configured to interact with a display of a virtual paper device, comprising:
an elongated body having a first end and a second end, wherein the first end and the second end exhibit different properties and are distinguishable by the display.

18. The user interface device of claim 17, wherein the first end includes a first tip, wherein the first tip has a thickness of between 0.1 millimeters and 1 millimeter.

19. The user interface device of claim 17, wherein the first and the second ends of the user interface device include of a reflective material having a microcrystalline structure.

20. The user interface device of claim 17, wherein the first and second ends include at least one of a magnetic material and a light emitting material.
